(19) United States
(12) Patent Application Publication
(10) Pub. No.: US 2005/0285736 A1
(43) Pub. Date: Dec. 29, 2005

(54) System and method for recognition of seat occupancy in a vehicle

(75) Inventors: Klaus Hofbeck, Neumarkt (DE); Birgit Rosel, Regensburg (DE)

Correspondence Address: LERNER AND GREENBERG, PA, P O BOX 2480, HOLLYWOOD, FL, 33022-2480, US

(73) Assignee: Siemens Aktiengesellschaft

(21) Appl. No.: 10/536,052

(22) PCT Filed: Nov. 19, 2003
(86) PCT No.: PCT/EP03/12965

§ 371 Date: May 20, 2005

(30) Foreign Application Priority Data
Nov. 20, 2002 (DE) 10254198.1

(51) Int. Cl. G08B 13/18; B60Q 1/00

(52) U.S. Cl. 340/552; 340/425.5

(57) ABSTRACT

A system, for recognition of seat occupancy in a vehicle, comprises a microwave transmitter (10), a microwave receiver (10) and preferably a reflector (12). If a person is located between said objects the microwave radiation is thus weakened. A back-scatter device can be used as reflector (12), such that radiation received by the receiver (10) can be unambiguously assigned to the reflector (12). In addition or alternatively a run-time measurement for the microwave radiation can be carried out and the above further processed with an analysis of the seat position. It is possible to use the refraction properties of the microwave radiation around the object in order to obtain further information about the seat position. The recognition of whether and optionally how a seat is occupied can preferably be used for the locking or activation of an airbag.

The invention relates to a system for detecting the seat occupancy in a vehicle, with one or more microwave transmitters and one or more microwave receivers, the one or more microwave transmitters and the one or more microwave receivers being arranged in such a way that microwave radiation transmitted by the one or more microwave transmitters over a radiation path can reach the one or more microwave receivers at least when the seat is unoccupied, and in such a way that depending on the seat occupancy an object can be on the radiation path, so that the radiation received by the microwave receiver can be influenced in accordance with the seat occupancy.

The invention also relates to a method for detecting the seat occupancy in a vehicle, with the following steps: Transmitting microwave radiation and receiving microwave radiation, in such a way that the transmitted microwave radiation propagates over a radiation path and in such a way that, depending on the seat occupancy, an object can be on the radiation path, so that the radiation received can be influenced in accordance with the seat occupancy.

Systems and methods of this kind are known. They are used in particular to influence the deployment of an airbag in accordance with the seat occupancy.

An example of such a system and method is known from U.S. Pat. No. 6,199,904 B1. In this, microwaves are sent by a microwave transmitter to a reflecting structure in a vehicle seat. The reflected microwaves are detected by a microwave receiver. Since the intensity of the reflected microwaves depends on whether the microwave radiation is impeded by a person occupying the seat, a conclusion about occupancy of the seat can be drawn from the result of an analysis. A disadvantage of the system and method is, however, that control of the airbag is not always based on reliable analysis. For example reflection can occur from objects other than the reflective object provided for that purpose in the seat. It would then be mistakenly assumed that the seat was not occupied, and the airbag could be disabled as a result. This could have fatal consequences for the passengers in the vehicle. Furthermore the calibration needed in connection with this design is very expensive, driving up the cost of the system. Moreover every additional analysis involves computing time, which would conflict with dynamic measurement, that is, a measurement taking place only when the vehicle is in a collision.

The object of the invention is to provide a system and a method which overcome the disadvantages of the prior art and in particular which make it possible to detect seating occupancy reliably and cost-effectively.

This object is achieved by means of the features of the independent claims.

Advantageous embodiments of the present invention are specified in the independent claims.

The invention is based on the kind of system in which the position of the object in the radiation path affects the intensity received from the microwave transmitter by virtue of the diffraction of the microwaves around the object, and the intensity received from the microwave transmitter provides information on the position of the object. Since microwave radiation, unlike infra-red radiation for instance, can exhibit marked diffraction fringes by reason of its wavelength when an object is placed in the radiation path, it is possible to make use of the changes in intensity that occur due to diffraction effects. For example it is possible to detect when a person is leaning forward in a seat if on the one hand said person sufficiently shields a reflector arranged in the seat surface, and/or on the other hand uncovers a reflector arranged in the seat back to the extent that microwaves diffracted around the object can reach the said reflector. In this way an empty seat can be distinguished from a seat occupied by an adult and also for example from a seat holding a child and a child seat, since in the last case, due to the higher position occasioned by the child seat, diffraction of microwave radiation can also occur at a reflector arranged in the surface of the seat.

It is particularly advantageous to provide, on the radiation path between the microwave transmitter and the microwave receiver, one or more reflectors which divide the radiation path into at least one first radiation path and at least one second radiation path. In principle it would be possible to arrange for example a microwave transmitter in the cockpit or in the area of the roof console of a motor vehicle and microwave receivers in the seats. It would also be possible to arrange these items the opposite way around. It can also be particularly useful to arrange the microwave transmitter and microwave receivers at preferably the same position and fit the seats with reflectors.

In this connection it is especially useful for the minimum of one reflector to be a modulating back-scatter process. Modulation of the microwave radiation by the back-scatter device makes it possible to distinguish the reflector from other metallic conducting objects without any difficulty. Thus if for instance the microwave radiation is reflected in the casing of a laptop being used by a passenger in a private motor car, this does not lead the system to suppose that a seat is unoccupied. An airbag would therefore deploy in the event of a collision.

The terms “reflector, reflecting, etc.” are used in the present disclosure with a very general meaning. For instance they mean not only reflections in the classic sense, but also the reflection of electromagnetic radiation by a back-scatter process.

The invention has further particularly advantageous features in that the path used by the microwave radiation between the microwave transmitter and the microwave receiver can be determined by measuring the propagation time. It is then possible to determine the occupancy of the seat. This makes further information available to an airbag control unit.

In this connection it is especially useful that the position of a seat can be determined, and that from the result of determining the path and determining the position of the seat it is possible to determine whether the radiation received by the microwave receiver has propagated over the radiation path between the microwave transmitter and the microwave receiver. Such considerations of plausibility are mainly superfluous when a modulating back-scatter device is used as a reflector, but may nevertheless be applied in the sense of redundancy. However these considerations are particularly useful with regard to the propagation time of the microwave signals, for example if no patterns have been modulated onto the reflected microwave radiation by a back-scatter process. By further analyzing the position of the seat it is then possible to determine whether the reflection at a reflector may for example come from the seat back or whether for example the reflection comes from a laptop on the passenger's knee.

It is especially advantageous if the back-scatter device is a modulating back-scatter device. Due to the pattern produced by modulation, the reflection can be unequivocally attributed to a back-scatter device.

It is especially advantageous for the one or more microwave transmitters and the one or more microwave receivers to be produced in the form of one or more microwave transmitting and receiving devices with transmitting and receiving antennas. The microwave radiation then travels from the microwave transmitting and receiving device via the first radiation path to the reflector and from the reflector via the second radiation path back to the microwave transmitting and receiving device, the one or more first radiation path and the one or more second radiation path being for the most part identical. The microwave transmitting and receiving device may be located in the instrument panel of the vehicle, for example. If the reflector is arranged in the back of the seat that is being monitored, in certain cases the beam path of the transmitted and reflected microwave radiation passes through the upper trunk area of a passenger. A person who sits normally on the seat covers the reflector, and the level received by the receiving antenna is some six orders of magnitude lower than when the person is absent. When the antenna is arranged in the instrument panel or in the cockpit and the reflector is arranged in the seat back it is certainly possible to detect when a person is not seated in the usual position. For example if the person leans forward, a proportion of the transmitted microwave radiation can reach the reflector due to diffraction around the body. This typical pattern is transmitted to the airbag control unit, which then analyzes whether the airbag can still be deployed. Likewise arranging the antenna in the cockpit and the reflector in the seat back means that for example a child seat can be transported safely on the passenger seat. The greater proportion of the microwave radiation will reach the reflector unhindered and return from there to the receiver, so that deployment of an airbag can be prevented, since the child seat consists generally of plastic and the radiation is attenuated by the child's body.

As an additional safety measure it is possible to fit a further reflector on the child seat. This ensures that microwave radiation is reflected that would otherwise be absorbed by the child seat or by the child sitting in that seat. Deployment of the airbag can then still be reliably prevented. If modulating back-scatter devices are used as reflectors, the back-scatter devices in the seat support or on the child seat can modulate the signals differently, making it possible to detect unequivocally that the seat is occupied by a child seat.

An especially useful feature is the provision of a control unit which triggers, disables or enables functions in the vehicle depending on the radiation received by the microwave receiver. Seat occupancy detection can also be worthwhile in conjunction with other functions in the vehicle, but the capability to enable or disable an airbag is a particularly important achievement of the present invention.

This can also be designed so that for example the minimum of one reflector is an electrically conducting film. Such a film can easily be incorporated into a seat back, needing almost no additional room and contributing hardly any additional weight.

The system to which the invention relates can have further embodiments in which the back-scatter device is produced in the form of a passive, semi-passive, semi-active or active back-scatter device. Passive back-scatter devices are particularly simple to construct. They need no additional energy supply and thus provide an especially cost-effective solution. Semi-passive back-scatter devices are operated with the aid of an additional amplifier which consumes a small amount of power. Compared to passive back-scatter devices they have the advantage that reflections can have a higher intensity. For this reason they can be more reliably analyzed. Particularly reliable analysis would be provided by an active back-scatter device, that is, a back-scatter device with active electronic components. This particularly reliable analysis is made possible by the higher microwave intensity. On the other hand the microwave radiation loading on the vehicle passengers is higher in this embodiment of the present invention than in the case of passive back-scatter devices. Semi-active back-scatter is similar to semi-passive back-scatter, but the signal that is to be reflected is amplified.

The system to which the invention relates can advantageously be designed so that the one or more microwave transmitters and/or the one or more microwave receivers are components of an access control and deployment start-up system installed in the vehicle. In microwave-based access control and start-up systems, the antenna for covering the passenger compartment is generally in such a position that it can also address the reflectors installed in the vehicle seats. Consequently, due to the embodiment of the present invention, in which components of the access control and start-up system are used for detecting seat occupancy, an integrated and therefore cost-reducing measure can be made available.

On comparable grounds it can be advantageous that analysis of the signals received by the microwave receiver should be supported or carried out in ways which are used in the context of an access control and start-up system installed in the vehicle.

Another useful possibility is to provide a plurality of different modulating back-scatter devices. For example said devices can be fitted in the seat back at different heights. If these reflectors are coded differently, it is then possible to detect not only whether a seat is occupied but also the height and sitting position of the passenger concerned. This information can be taken into account for instance in the deployment of an airbag or a plurality of airbags at different positions.

Advantageously the system to which the invention relates is designed so that the radiation path is a straight line. In the present connection, any mention of a straight-line radiation path relates to propagation of the radiation in the absence of diffraction fringes. The accompanying embodiments therefore relate to the geometrical arrangement of the components. Thus there exists a direct line of sight between the transmitter, the reflector and the receiver. This approach produces a particularly simple system.

However it can also be useful that the radiation path is a detour. The microwave radiation can be guided through the vehicle with the aid of conducting materials built into the vehicle so that specific zones can be deliberately illuminated without the need for microwave transmitting and receiving devices.

The invention is based on the type of method in which the position of the object in the radiation path affects the received intensity by virtue of the diffraction of the microwaves around the object, and the received intensity provides information on the position of the object.

The advantages and special features of the inventive system are based on the inventive method. This also applies to the following especially preferred embodiments of the inventive method.

It is particularly useful that at least one reflection should take place on the radiation path, said radiation path being divided into at least one first radiation path and at least one second radiation path.

Another useful possibility is that the reflection takes place by means of a modulating back-scatter process.

The invention can have further particularly advantageous features in which the path used by the microwave radiation is determined by measuring the propagation time, in particular when the radiation is reflected without modulation.

The inventive method provides further advantageous features if designed so that the position of a seat is determined, and so that the result of determining the path and the result of determining the position of the seat then determine whether the received radiation was propagated over the radiation path.

It is especially advantageous if the back-scatter process is a modulating back-scatter process.

The inventive method also provides particularly advantageous features if designed so that the one or more first radiation path and the one or more second radiation path are identical.

It is a particularly useful feature that functions in the vehicle are triggered, disabled or enabled depending on the radiation received by the microwave receiver.

The inventive method can also be designed so that for example an electrically conducting film is used for reflecting.

The inventive method can have further embodiments in which the back-scatter process is produced by a passive, semi-passive, semi-active or active back-scatter device.

The inventive method can very advantageously be designed so that transmission and/or receiving take place by virtue of an access control and start-up system installed in the vehicle.

On comparable grounds it can be advantageous that analysis of the received signals should be supported or carried out by means which are used in the context of a microwave-based access control and start-up system installed in the vehicle.

Another useful possibility is for the back-scatter process to be produced by a plurality of different modulating back-scatter devices.

Advantageously the method to which the invention relates is designed so that the radiation path is a straight line.

However it can also be useful that the radiation path is a detour.

The invention is based on the recognition that it is possible to produce a highly reliable yet simple and cost-effective method for detecting seat occupancy by using a back-scatter device as the reflector, in particular a modulating back-scatter device. Likewise the reliability of the system can be improved by ensuring that the microwave radiation reflection point is checked against a seat position which has been separately determined by measuring the propagation time. A further advantageous possibility can be to use diffraction fringes of the microwave radiation. Since microwave radiation is strongly but not completely absorbed by the human body, it is advantageous to use microwave radiation compared to other wave forms such as ultrasound, laser radiation or light and infra-red radiation. The propagation of microwave radiation takes place regardless of pressure, temperature, brightness and other environmental conditions. The measurement method is very fast due to the simplicity of the analysis, so that dynamic measurement, for instance only in the case of a collision, becomes a possibility. Other preferred features of the invention can be recognized from the fact that seat occupancy can be detected with very great speed. The time for acquisition is typically in the millisecond range. For this reason it is possible to send the airbag controller a dynamic response so that after an airbag has already deployed in accordance with the seat occupancy or the leaning position of the person in the seat, it is possible for example to influence the filling of the airbag, preferably by reducing the pressure.

The features and advantages of the invention will emerge from especially preferred typical embodiments and by reference to the accompanying drawings, in which;

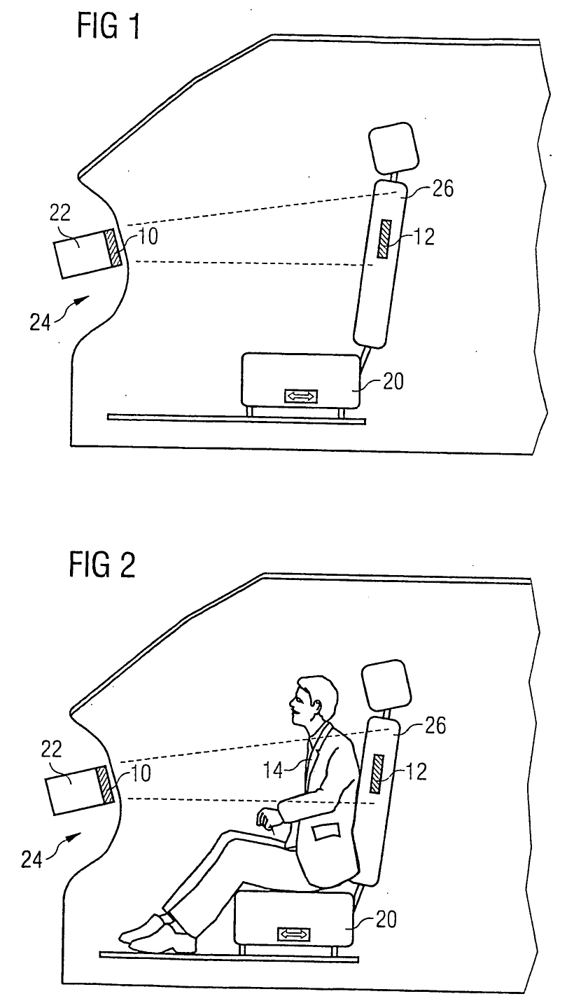

FIG. 1 shows a preferred embodiment of an inventive system;

FIG. 2 show the embodiment according to FIG. 1 with a person in a first sitting position;

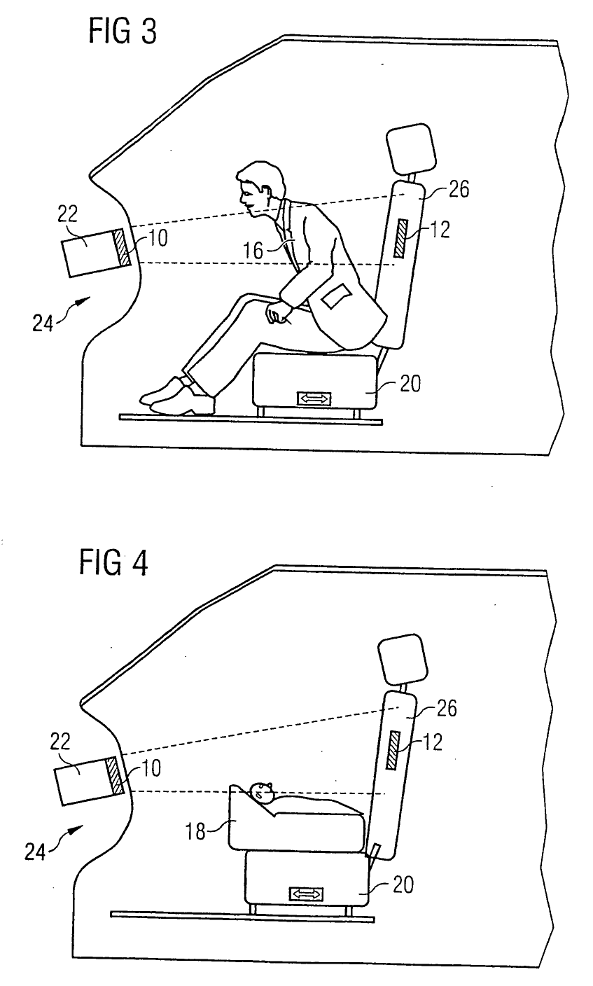

FIG. 3 show the embodiment according to FIG. 1 with a person in a second sitting position;

FIG. 4 shows the embodiment according to FIG. 1 with a seat occupied by a baby seat;

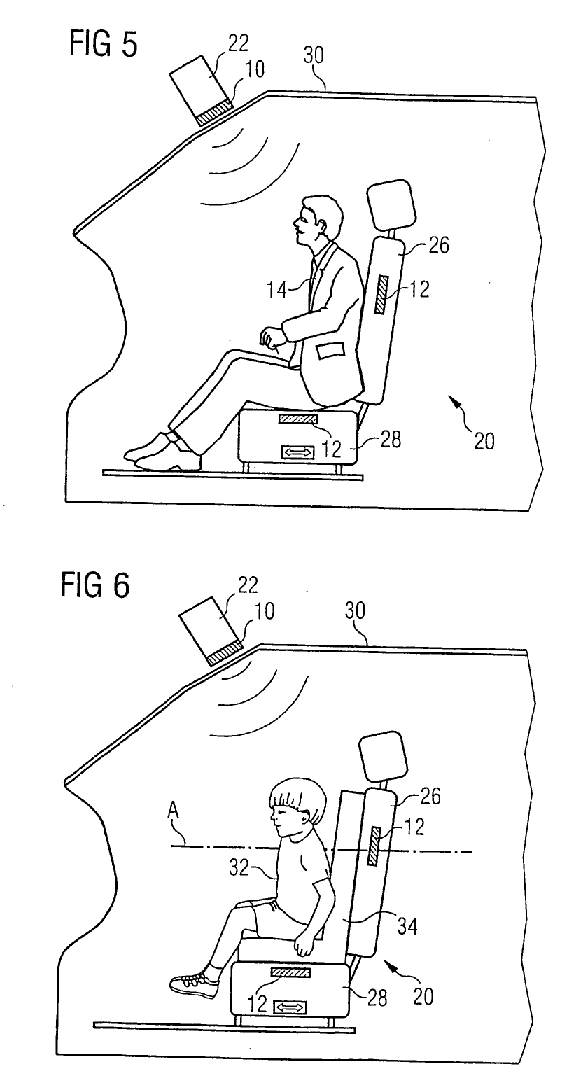

FIG. 5 show a further preferred embodiment of an inventive system with a first person;

FIG. 6 shows the embodiment according to FIG. 5 with a second person; and

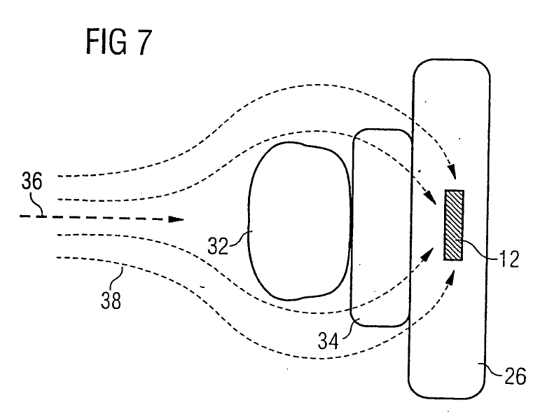

FIG. 7 shows a sectional view from above of the arrangement shown in FIG. 6.

In the description which follows of preferred embodiments of the present invention the same reference numbers designate the same or comparable components.

FIG. 1 shows a preferred embodiment of an inventive system. A microwave transmitting and receiving device 10 is arranged in the instrument panel or in the cockpit 24 of a vehicle. In the back 26 of a vehicle seat 20 a reflector 12 is arranged; depending on the embodiment, this can be designed as a modulating back-scatter device or as a simple electrically conducting film or non-modulating back-scatter device. The seat 20 can be moved in the usual way, for which reason it is particularly preferred that the position of the seat 20 can be determined.

The microwave transmitting and receiving device 10 transmits microwave radiation toward the reflector 12. This microwave radiation is reflected by the reflector 12 and returned to the microwave transmitting and receiving device 10. The reflector 12 can reflect by conventional means, for example if the reflector 12 is a simple electrically conducting film.

However, the reflection 12 can take place in the context of a modulating back-scatter process, in which encoding can be imprinted on the reflected radiation, for example by means of modulation. For this purpose the reflector 12 can be designed as a passive, semi-passive, semi-active or active back-scatter device.

In a control unit 22 the signals emitted by the reflector 12 can be analyzed for distance, level and quality.

In the situation shown in FIG. 1, there is nobody on the seat 20. The reflected signal is therefore received with a high level and a high quality.

As well as the embodiment with a reflector 12 in the seat 20 it is also possible to implement the present invention without using a reflector. In this case, for example, a microwave receiver may be arranged in the seat 20, for instance at the point where the reflector 12 is placed in FIG. 1. In a further embodiment these receiver and reflector positions can even be exchanged. These principles also apply to the embodiments of the present invention which are described below.

FIG. 2 shows the embodiment according to FIG. 1 with a person in a first sitting position. In this illustration a person 14 is sitting normally on the seat 20 and is covering up the reflector 12. For this reason the microwave transmitting and receiving device 10 receives a signal which is weaker by many orders of magnitude, for example by six orders of magnitude, than the signal when the seat is unoccupied. In this case deployment of the airbag can be enabled, and the airbag will be deployed in the event of an accident.

FIG. 3 shows the embodiment according to FIG. 1 with a person in a second sitting position. The person 16 shown here is leaning forward. If the upper body of the person is far enough forward of the reflector 12, quite a high intensity can be transmitted once more from the microwave transmitting and receiving device to the reflector and back again from the reflector to the microwave transmitting and receiving device. The intensity can be used for detecting the angle at which the person is leaning. With effect from a certain leaning angle, deploying the airbag is no longer advisable for fear of causing head injuries; this situation is known as the out-of-position case. If the reflector and therefore the out-of-position case are detected, deployment of the airbag can be prevented. The critical leaning angle after which the out-of-position case is detected can be adjusted as a function of the wave length, the level or intensity, the area of the reflector, the attachment points of the reflector and of the microwave transmitting and receiving device, the analytical algorithm, etc.

FIG. 4 shows the embodiment according to FIG. 1 with a seat occupied by a baby seat. In this case a baby is in a child seat, lying in a seat 18 of a type known as a Reboard. This is attached normally to the passenger seat 20. Due to the relative positions of the microwave transmitting and receiving device 10, reflector 12 and Reboard seat 18, only slight attenuation of the microwave radiation occurs. Deployment of the airbag is consequently prevented. Additionally it is possible and in certain circumstances very useful to attach a reflector to the back of the Reboard seat 18. It is then possible to distinguish the situation with a child seat 18 on the seat 22 from the situation where there is no object on the seat 20, for example with the aid of special modulation of the microwave radiation by this reflector, or on the basis of propagation time measurement.

For example in the system to which the invention relates, if the reflector 12 is obscured by a metal object, this causes a strong reflection. The intensity of this reflection may be in the same order of magnitude as the intensity of the reflection from the reflector 12. There are then different options regarding how the control unit 22 can detect the different situations. If the reflector is a modulating back-scatter device with unequivocal coding, then on this basis the reflection due to the obscuring metal object is unequivocally detected. Alternatively or in addition, the reflection from an obscuring metal object can be recognized on the basis of propagation time measurement, particularly if the propagation time is compared with the actual seat position, which can be determined with the aid of an additional sensor.

Likewise it is advantageous that objects with or without low electrical conductivity in front of the reflector 12 should shield the reflector only slightly. The signals received by the control unit then match the “empty seat” situation, and deployment of the airbag is correctly disabled.

FIG. 5 shows a further preferred embodiment of an inventive system with a first person. In this exemplary embodiment two reflectors 12 are built into the vehicle seat 20. A reflector 12 is arranged in the seat back 26; a further reflector 12 is arranged in the seat surface 28. The control unit 22 with microwave transmitter and receiver 10 is arranged in the roof console 30 of a vehicle; receiver 10 is arranged in the roof console 30 of a vehicle.

A grown person 14 sitting normally on the seat will cover the reflectors 12, and the level received by the control unit 22 is several orders of magnitude lower than in the case of an empty seat 20. In this respect the system according to FIG. 5 works in a comparable way to the systems described in connection with FIGS. 1 to 4. However, since an additional reflector 12 is now arranged in the seat surface 28, it is possible to detect with greater reliability whether the person 14 is leaning forward. In such cases the person 14 fully reveals the reflector 12, and microwave radiation, at least in the form of diffraction fringes, can then find its way between the microwave transmitter/receiver 10 and the reflector 12 in the seat back 26. The reflector 12 in the seat surface 28, on the other hand, is still completely covered by the person 14, and this can be used as additional information to confirm that the object is a person 14 leaning forward and not an empty seat 20.

FIG. 6 shows the embodiment according to FIG. 5 with a second person. On the basis of the inventive system, the situation shown here can also be distinguished from an adult leaning forward, as was previously explained with the aid of FIG. 5. A child 32 is sitting on a child seat 34 which is arranged on the seat 20. As before, two reflectors 12 are arranged in the seat 20, one in the seat back 26 and one in the seat surface 28. Due to the child seat 34, which in general absorbs microwaves very much less than the body of the child 32, microwaves can find their way between the microwave transmitter/receiver 10 and the reflectors 12 in the seat back 26 or in the seat surface 28, particularly on account of the diffraction properties. The reflector 12 in the seat surface 28 therefore receives a higher intensity than would be the case if an adult were sitting directly on the seat surface 28.

Thus with a suitable arrangement of a plurality of reflectors 12 and an equally suitable arrangement of the microwave transmitter/receiver 10, different situations can be detected with regard to the seat occupancy in the vehicle.

FIG. 7 shows a sectional view of the arrangement in FIG. 6, seen from above. The section in FIG. 7 is taken at the level labeled A in FIG. 6. It shows different paths by which microwave radiation can reach the reflector 12 in the back support 26, from which the situation of a child 32 on a child seat 34 will be assumed. On the one hand there is the direct path 36 between the microwave transmitter/receiver 10 and the reflector 12, which in this situation is shielded by the child 32. However, due to the separation between the child 32 and the reflector 12, which is held constant by the child seat 34, microwaves can also travel from the microwave transmitting and receiving device 10 to the reflectors 12 and back again along indirect paths 38, for example as a result of diffraction around the body and due to reflection or scattering. This is hampered only to an insignificant extent by the child seat 34, which has a very low absorption capacity compared to the human body.

The invention can be summarized as follows. A system for recognition of seat occupancy in a vehicle comprises a microwave transmitter 10, a microwave receiver 10 and preferably a reflector 12. If a person is located between said objects the microwave radiation is thus weakened. A modulating back-scatter device can be used as a reflector 12, such that radiation received by the receiver 10 can be unambiguously attributed to the reflector 12. In addition or alternatively, a propagation time measurement of the microwave radiation can be carried out and further processed together with an analysis of the seat position. Propagation time measurement, which in effect is a measure of distance, is carried out in particular when the radiation is not modulated by the reflector.

It is possible to use the diffraction properties of the microwave radiation around the object in order to obtain further information about the seat position. The recognition of whether and optionally how a seat is occupied can preferably be used for the locking or activation of an airbag.

The features of the invention disclosed in this description, in the drawings and in the claims can be significant, both individually and in any combination, for the accomplishment of the invention.

1-30. (canceled)

31. A system for determining an occupancy of a vehicle seat in a vehicle, comprising:
at least one microwave transmitter;
at least one microwave receiver; and
at least one reflector in the form of a modulating back-scatter device;
wherein said at least one microwave transmitter and said at least one microwave receiver are disposed such that:
microwave radiation transmitted by said at least one microwave transmitter over a radiation path reaches said at least one microwave receiver, at least when the vehicle seat is unoccupied; and
when the vehicle seat is occupied, an object may be in the radiation path, and radiation received by said microwave receiver is influenced in accordance with the seat occupancy, and an intensity received by said at least one microwave receiver and affected by diffraction provides information on a position of the object in the radiation path.

32. The system according to claim 31, wherein said at least one microwave transmitter and said at least one microwave receiver are implemented in at least one microwave transmitting and receiving device with transmitting and receiving antenna.

33. The system according to claim 31, which comprises a control unit configured to trigger, disable or enable functions in the vehicle depending on a radiation received by said at least one microwave receiver.

34. The system according to claim 31, wherein said at least one reflector is an electrically conducting film.

35. The system according to claim 31, wherein said back-scatter device is a device selected from the group consisting of passive, semi-passive, semi-active, and active back-scatter devices.

36. The system according to claim 31, wherein said at least one microwave transmitter and/or said at least one microwave receiver form a part of an access control and start system of the vehicle.

37. The system according to claim 31, wherein the signals received by said microwave receiver are processed for analysis with means used in an access control and start system installed in the vehicle.

38. The system according to claim 31, wherein said at least one reflector is one of a plurality of different modulating back-scatter devices.

39. The system according to claim 31, wherein said microwave transmitter and said reflectors are disposed to define a radiation path running in a straight line.

40. The system according to claim 31, wherein said microwave transmitter and said reflectors are disposed to define radiation paths running with diversions.

41. A method for determining a seat occupancy in a vehicle, which comprises the following steps:
transmitting microwave radiation to cause the transmitted microwave radiation to propagate over a radiation path, wherein, depending on the seat occupancy, an object may be present in the radiation path, whereupon the radiation received may be influenced in accordance with the seat occupancy;
reflecting the microwave radiation with a modulating back-scatter process; and
receiving reflected microwave radiation and deducing, from a received intensity affected by diffraction of the radiation, information on the position of the object in the radiation path.

42. The method according to claim 41, which comprises further utilizing the received signal for triggering, disabling, or enabling functions in the vehicle.

43. The method according to claim 41, which comprises utilizing an electrically conducting film for reflecting.

44. The method according to claim 41, which comprises providing backscatter devices selected from the group consisting of passive, semi-passive, semi-active, and active backscatter devices.

45. The method according to claim 41, which comprises transmitting and/or receiving with an access control and start system installed in the vehicle.

46. The method according to claim 41, which comprises carrying out or supporting analysis of the received signals within a framework of a microwave-based access control and start system installed in the vehicle.

47. The method according to claim 41, which comprises producing the back-scatter process with a plurality of different modulating back-scatter devices.

48. The method according to claim 41, which comprises causing the radiation to follow a straight line radiation path.

49. The method according to claim 41, which comprises causing the radiation to follow a diversion route.
